(19) United States
(12) Patent Application Publication
(10) Pub. No.: US 2019/0133346 A1
(43) Pub. Date: May 9, 2019

(54) APPARATUS FOR A COMBINATION AUTO VISOR AND DESK PHOTO FRAME

(71) Applicants: Sanford H. Cohen, Miami, FL (US); Glenn Akhavein, Bradenton, FL (US)

(72) Inventors: Sanford H. Cohen, Miami, FL (US); Glenn Akhavein, Bradenton, FL (US)

(21) Appl. No.: 15/993,054

(22) Filed: May 30, 2018

Related U.S. Application Data
(60) Provisional application No. 62/512,294, filed on May 30, 2017.

(51) Int. Cl. A47G 1/06; B60J 3/02; B60R 11/00; A47G 1/14

(52) U.S. Cl. CPC A47G 1/06; B60J 3/0278; B60R 11/00; A47G 2001/0694; B60R 2011/0035; B60R 2011/0059; A47G 1/143

(57) ABSTRACT

A frame apparatus adapted to use on any surface structure, is disclosed. The apparatus comprises a frame, a frame cover and a visor clip mount, a frame comprising one or more flanges extends from a peripheral edge of the frame. A frame cover comprises at least two recess for receiving a picture, wherein the frame is fastened to the frame cover. The flanges are adapted to overhang the frame cover to secure the frame, picture and transparent frame cover in assembled condition. The visor clip mount is disposed at a rear side of the frame configured to receive a visor clip. The apparatus further comprises a stand mount adapted to hingedly fasten a stand. The stand enables the frame apparatus to be placed on a flat surface and the visor clip enables the frame apparatus to fit on an automobile visor.

### CROSS REFERENCE TO APPLICATION

This patent application claims the benefit of U.S. Provisional Application No. 62/512,294 filed on May 30, 2017. The above application is incorporated by reference herein in its entirety.

### BACKGROUND OF THE INVENTION

### A. Technical Field

The present invention relates generally to a combination auto visor and desk photo frame, and more particularly, to an apparatus for a double and single sized photo frame that is specifically tailored for use in an automobile (clipped onto the visor) as well as for use on a flat surface such as a desk or shelf.

### B. Description of Related Art

Picture frames are well known in the art for displaying pictures, certificates and other mementoes. Picture frames are designed to hold one or more pictures in a viewable position to allow observation without touching the picture.

One such mass produced picture frame has a perimeter frame, e.g. of wood with mitred corner joints or alternatively of plastics, a transparent front panel of plastics or glass, and a rear opaque panel typically of fibre board or plastics. The picture is sandwiched between the front and rear panels, which are themselves received in a recess formed around the rear of the perimeter frame and held in position typically by flexible metal tabs driven into the perimeter frame, which are bent into position against the rear panel. To enable the frame to stand upright, the rear panel has cuts or perforations pre-formed in it to define a leg which can be bent backwardly out of the plane of the panel.

While commercially successful, such frames are not without shortcomings. Their appearance is not appropriate in some contexts; the leg can sometimes fold inward allowing the frame to topple backward, and abuse can cause the material forming the hinge for the leg to fail. Further, such frames are limited to use only on flat horizontal surfaces and cannot be used on surfaces like automobile visor.

Therefore, there is a need for a frame apparatus, which could be placed on any surface such as a flat surface and other surface like automobile visor.

### SUMMARY OF THE INVENTION

The design shown here is of the double picture frame, however, the single functions exactly as the double except that it only has one visor clip at this time. The double is made up of a Frame, Frame Cover, Stand, and two Clips (the Clips are identical).

A frame apparatus adapted to use on any surface such as a flat surface and surface like automobile visor, is disclosed. In one embodiment, the apparatus comprises a frame, a frame cover and a visor clip mount. The frame comprising one or more flanges extends from a peripheral edge of the frame. The frame cover comprises at least two recess of predefined dimensions formed thereon for receiving a picture or photograph. The frame cover is fastened to the frame, wherein the flanges are adapted to overhang the frame cover to secure the frame, picture and frame cover in assembled condition.

In another embodiment, a portion of a side edge of the frame comprises a concave region. The concave region is adapted to enable easy removal of the frame cover. The visor clip mount is disposed at a rear side of the frame configured to receive a visor clip.

In one embodiment, the visor clip mount comprises an upper mount, a visor clip lock and a lower mount on a same plane and a clip retainer adjacent to the upper mount. The visor clip comprises a U-shaped configuration having a pair of legs, wherein the pair of legs comprises a first leg and a second leg having a circular hook-type end. The first leg is inserted into the upper mount and snapped into the lower mount, and a second leg is hooked to the clip retainer via the circular hook. In another embodiment, the visor clip comprises a characteristic shape adapted to fasten to the visor clip mount via a snap fit configuration. In yet another embodiment, the visor clip comprises an L-shaped structure. In yet another embodiment, the visor clip comprises a U-shaped structure.

In another embodiment, the apparatus further comprises a stand mount having a pair of slots disposed integrally at a rear side of the frame, wherein the stand mount is configured to hingedly fasten a stand. In another embodiment, the apparatus further comprises a stand retainer. The stand retainer comprises an inwardly formed groove at a rear side of a lower peripheral edge of the frame. The stand is configured to retract inwardly to snugly fit in the groove of the lower peripheral edge of the frame. The stand is further configured to extend outwardly beyond the peripheral edge of the frame.

In yet another embodiment, the apparatus further comprises one or more apertures or picture adjustment openings, one or more apertures are disposed at the rear side of the frame, where the photograph is received, to enable to adjust the position of the photograph.

In yet another embodiment, the apparatus further comprises one or more hinges at a lower peripheral edge of the frame cover. In yet another embodiment, the apparatus further comprises one or more hinge openings disposed at a lower peripheral edge of the frame. Each hinge opening is adapted to receive at least one hinge therein on fastening the frame cover to the frame.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates an exploded view of the frame apparatus from the upper back side in an embodiment of the present invention.

FIG. 2 exemplarily illustrates the frame apparatus from the front with a frame cover open, in an embodiment of the present invention.

FIG. 3 exemplarily illustrates the frame apparatus from the front with the frame cover closed, in an embodiment of the present invention.

FIG. 4 exemplarily illustrates the main features of the frame apparatus in an embodiment of the present invention.

FIG. 5 exemplarily illustrates the visor clips and desk stand all folded down and locked in place by their retainers for packaging so that the product is a flat as possible.

FIG. 6 exemplarily illustrates the frame apparatus as used in a car, the circular ends of the visor clips are momentarily bent inwards so that they can clear the clip retainers and then the clips are rotated 90 degrees where they lock onto the clip locks.

FIG. 7 exemplarily illustrates the frame apparatus as used on a desk, the middle of the stand is pulled down slightly to clear the stand retainer and then rotated upwards about 40 degrees at which point it locks into the stand lock, in an embodiment of the present invention.

FIG. 8 exemplarily illustrates the frame apparatus from a side view on a desk in an embodiment of the present invention.

FIG. 9 exemplarily illustrates a perspective view of the apparatus in an embodiment of the present invention.

FIG. 10 exemplarily illustrates an exploded view of the apparatus in an embodiment of the present invention

FIG. 11 exemplarily illustrates a perspective view of a visor clip in an embodiment of the present invention.

FIG. 12 exemplarily illustrates a front perspective of a frame in an embodiment of the present invention

FIG. 13 exemplarily illustrates a top view of a frame cover in an embodiment of the present invention.

FIG. 14 exemplarily illustrates a perspective view of an apparatus in another embodiment of the present invention.

FIG. 15 exemplarily illustrates an exploded view of the apparatus in another embodiment of the present invention.

FIG. 16 exemplarily illustrates a perspective view of a visor clip in another embodiment of the present invention.

FIG. 17 exemplarily illustrates a front perspective of a frame in another embodiment of the present invention.

FIG. 18 exemplarily illustrates a top view of a frame cover in another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

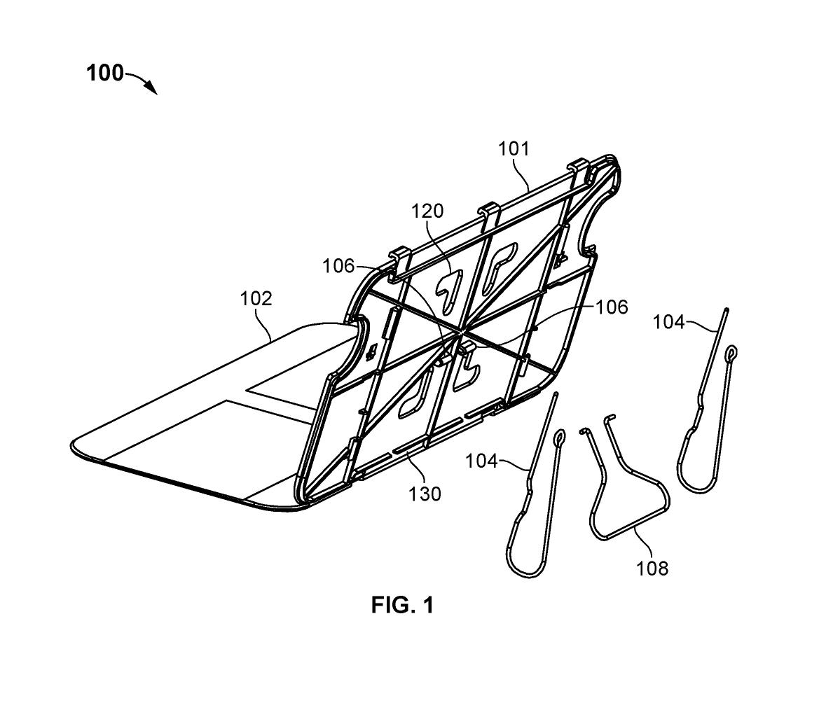

A frame apparatus adapted to use on any surface such as a flat surface and surface like automobile visor is, disclosed. The frame's design has three configurations that can be changed back and forth at any time. The main features of the frame's design can be seen by referring to FIGS. 1 through 18.

As previously stated, the frame apparatus is made up of a frame, frame cover, visor clip mount, stand mount, stand, and two visor clips, (the clips are identical). The frame Cover is made of optically clear Polycarbonate, PC, and has two small recesses that are designed to hold 3″×4″ pictures. The recesses run all the way out to the ends so that if the pictures are thin enough they can be inserted from the sides without having to unclip the cover.

The frame comprises one or more flanges extends from a peripheral edge of the frame. The frame cover comprising at least two recess of predefined dimensions formed thereon for receiving a picture or photograph, wherein the frame is fastened to the frame cover, wherein the flanges are adapted to overhang the frame cover to secure the frame, picture and transparent frame cover in assembled condition. The visor clip mount is disposed at a rear side of the frame configured to receive the visor clip. The stand mount is adapted to hingedly fasten the stand. The stand enables to use the frame apparatus on a flat surface and the visor clip enables to use the frame apparatus on an automobile visor.

FIG. 1 exemplarily illustrates an exploded view of the frame apparatus 100 from the upper back side. In an embodiment, the apparatus 100 comprises a frame 101, a frame cover 102, stand 108, at least two visor clips 104. Each visor clip 104 comprises a U-shaped configuration having a pair of legs. The pair of legs includes a first leg and a second leg having a circular hook-type end.

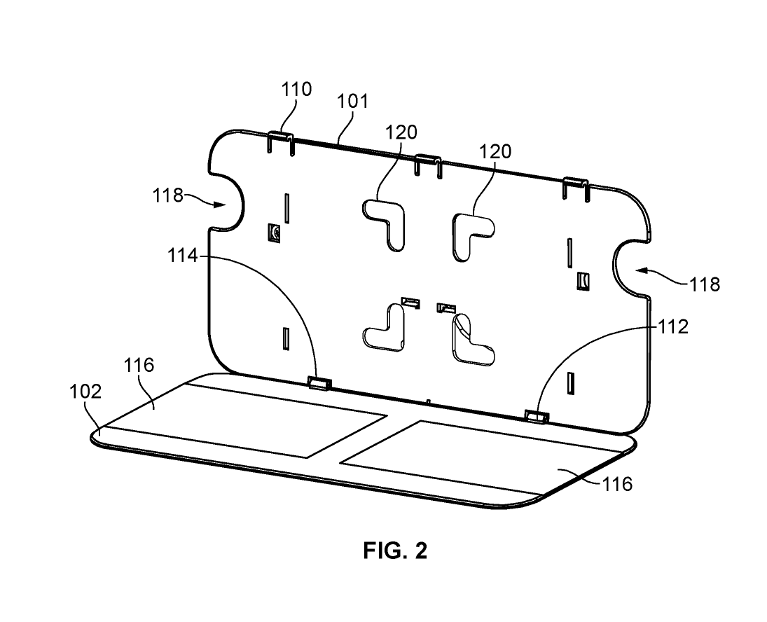

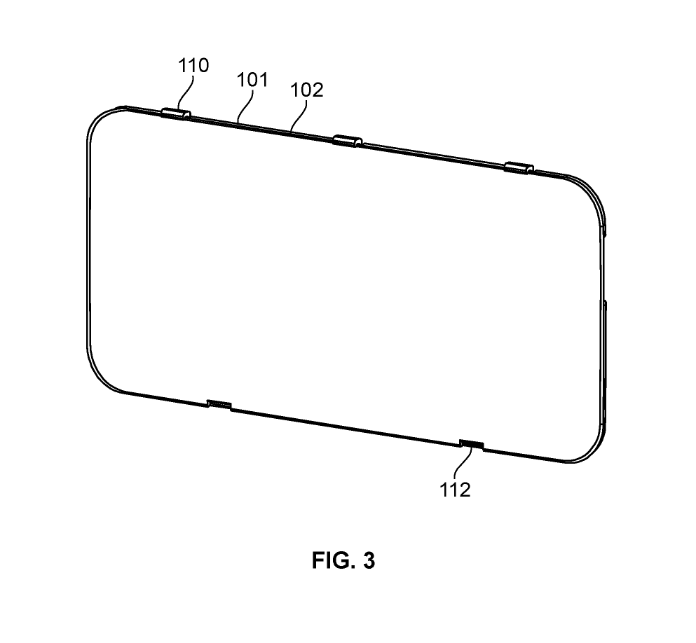

FIG. 2 exemplarily illustrates the apparatus 100 from the front with the frame cover 102 open. The frame 101 comprising one or more flanges 110 extends from a peripheral edge of the frame 101. The frame cover 102 comprises at least two recess 116 of predefined dimensions formed thereon for receiving a picture or photograph. Further, on loading the photograph or picture, the frame cover 102 is fastened to the frame 101 as illustrated in FIG. 3. In one embodiment, the frame cover 102 is made of optically clear Polycarbonate, PC. In on embodiment, the recess 116 is dimensioned to hold 3″×4″ pictures. The recesses 116 run all the way out to the ends so that if the pictures are thin enough they can be inserted from the sides without having to unclip the frame cover 102.

In one embodiment, the clips or flanges 110 are configured to hold the frame cover 102 in place, when the frame cover 102 is fastened to the frame 101. In one embodiment, the frame cover 102 further comprises hinges 112, (2×), that insert into hinge openings 114 in the frame 101 and allow the frame cover 102 to rotate forward as well as be removed.

In one embodiment, the apparatus 100 is made of Acrylonitrile butadiene styrene (ABS). In one embodiment, a front side of the frame 101 comprises a flat structure and the hinge opening 114 must not have any flash in the area that the frame cover 102 fastens.

FIG. 3 exemplarily illustrates the apparatus 100 from the front with the frame cover 102 closed. The flanges 110 are adapted to overhang the front cover 102 to secure the frame 101, picture and transparent frame cover 102 in assembled condition.

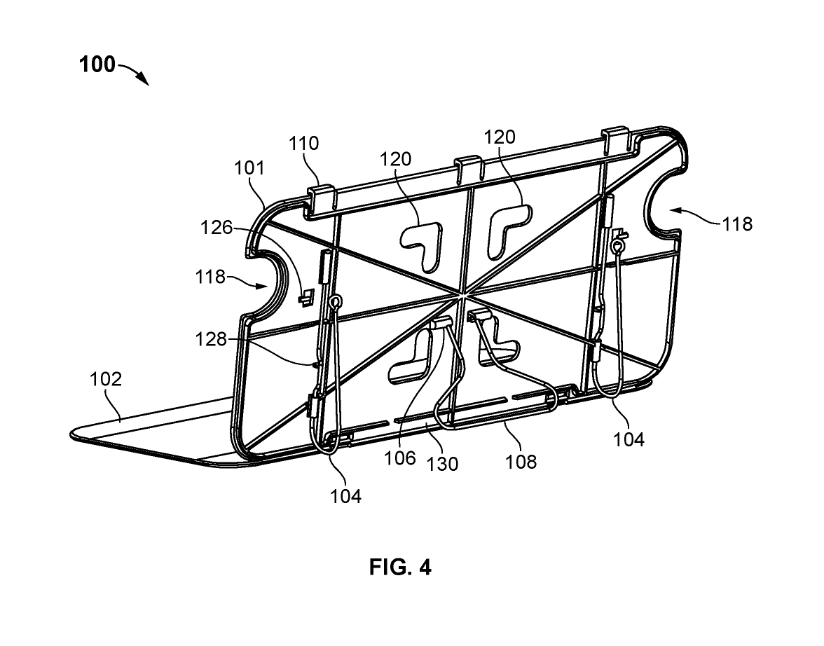

FIG. 4 exemplarily illustrates the main features of the apparatus 100. In an embodiment, the frame 101 comprises a geometrical shape. In another embodiment, a portion of a side edge of the frame 101 comprises a concave region 118. The concave region 118 is adapted to enable easy removal of the frame cover. In another embodiment, the frame 101 further comprises one or more apertures 120 to adjust the photograph placed within the apparatus 100. In one embodiment, the one or more apertures 120 comprises a geometric shape. In one embodiment, the apparatus 100 is rectangular in shape.

In one embodiment, the apparatus 100 further comprises a visor clip mount having an upper mount 122 and a lower mount 124 on a same plane and a clip retainer 126 adjacent to the upper mount 122. The visor clip 104 comprises a U-shaped configuration having a pair of legs, wherein the pair of legs comprises a first leg and a second leg having a circular hook type end. The first leg is inserted into the upper mount 122 and snapped into the lower mount 124, and a second leg is hooked to the clip retainer 126 via the circular hook.

In one embodiment, the apparatus 100 further comprises a stand lock and mount or stand lock 106 having a pair of slots is disposed integrally at a rear side of the frame 101, wherein the stand mount 106 is configured to hingedly fasten the stand 108. In one embodiment, the apparatus 100 further comprises a stand retainer 130. The stand retainer 130 comprises an inwardly formed groove at a rear side of a lower peripheral edge of the frame 101. The stand 108 is configured to retract inwardly to snugly fit in the groove of the lower peripheral edge of the frame 101. The stand 108 is further configured to extend outwardly beyond the peripheral edge of the frame 101.

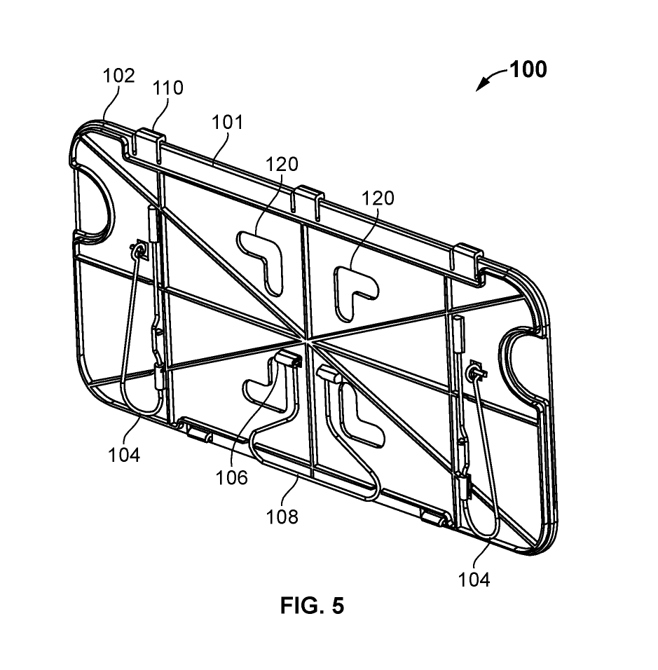

FIG. 5 exemplarily illustrates the Visor Clips 104 and Desk Stand 108 all folded down and locked in place by their retainers (130, 126) for packaging so that the apparatus 100 is a flat as possible.

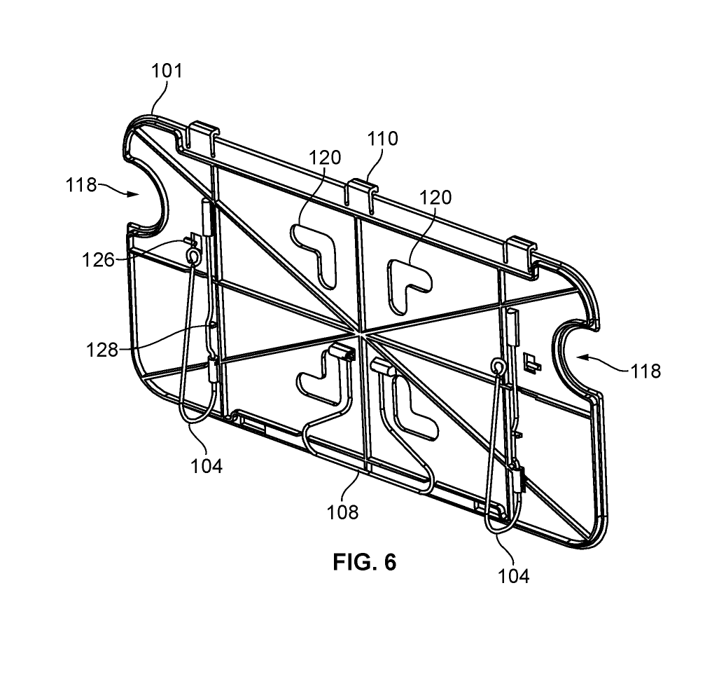

FIG. 6 exemplarily illustrates the apparatus 100 as used in a car, the circular ends of the visor clips 104 are momentarily bent inwards so that they can clear the clip retainers 126 and then the clips 104 are rotated 90 degrees where they lock onto a visor clip lock 128.

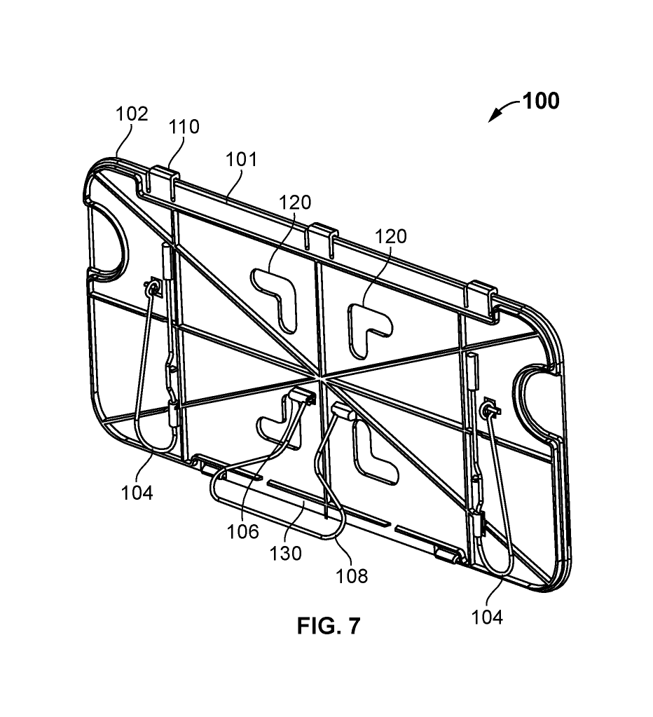

FIG. 7 exemplarily illustrates the apparatus 100 as used on a desk, the middle of the stand 108 is pulled down slightly to clear the stand Retainer 130 and then rotated upwards about 40 degrees at which point it locks into the Stand Lock 106.

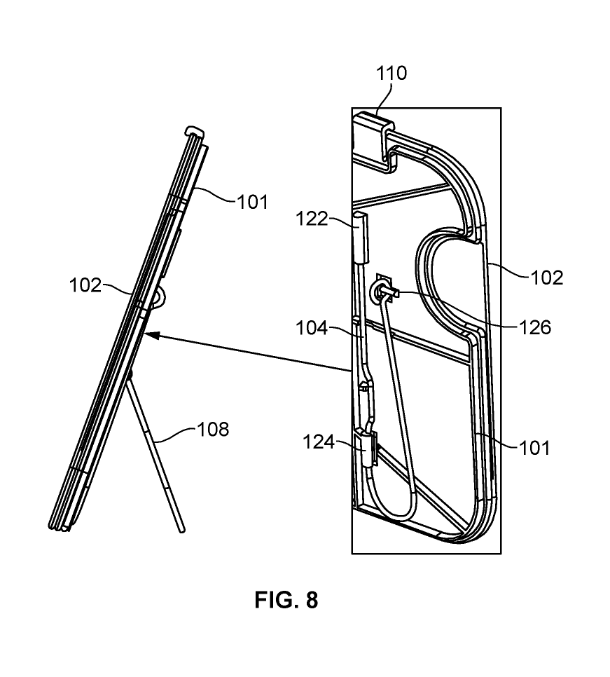

FIG. 8 exemplarily illustrates the apparatus 100 from a side view on a desk. In one embodiment, the visor clip 104 is inserted into the upper mount 122 and then snapped laterally into the lower mount 124 from the side, (see pictures below). Then the rounded end of the visor clip 104 is deflected enough to go over the clip retainer 126. When the apparatus 100 is packaged and when used on a desk, the visor clips 104 are placed in this position.

In another embodiment, at least two ends of the stand 108 are assembled into the stand mount and lock 106 while holding the stand 108 perpendicular to the frame 101. Compress the other tip enough to clear the other stand mount 106 and allow it to enter into the opening. Then compress both tips enough to rotate the stand 108 until it is parallel with the frame 101. At this time the middle of the stand 108 base can be pulled or pushed over the stand retainer 130 thus locking the Stand 108 in place. This position used during package of the apparatus 100 or when used in car.

Referring to FIG. 6, in one embodiment, during use of the apparatus 100 in a car, the rounded end of the visor clip 104 is deflected enough to clear the clip retainer 126 and then the visor clip 104 is rotated 90° and locked onto the visor clip lock 128. In one embodiment, the visor clip lock 128 is a dent. In one embodiment, the visor clip mount comprises a visor clip lock dent 128 between the upper visor mount 122 and the lower visor mount 124. The visor clip lock dent 128 is configured to lock the visor clip 104 in 90°.

In an embodiment, the FEA analysis of the stand 108 is disclosed. In one embodiment, the stand 108 and the stand designer are designed to be locked and unlocked without too much force having to be applied. The table above shows the results of the FEA analysis on the stand 108 as it travels from its natural position to the three positions it will be in; as packaged, on a desk, and moving between the two positions. The table shows travel, compressive force, and resultant stress.

| | | | | Stress | Stress | % |
|---|---|---|---|---|---|---|
| Position | Travel mm | Force Oz | Newtons | Ksi | Mpa | Yield |
| Desk | 2.40 | 2.27 | 0.63 | 10.71 | 73.85 | 8.1 |
| Packaged | 4.00 | 3.79 | 1.05 | 18.00 | 124.11 | 13.6 |
| Moving | 6.90 | 6.62 | 1.84 | 31.81 | 2149.33 | 24.1 |

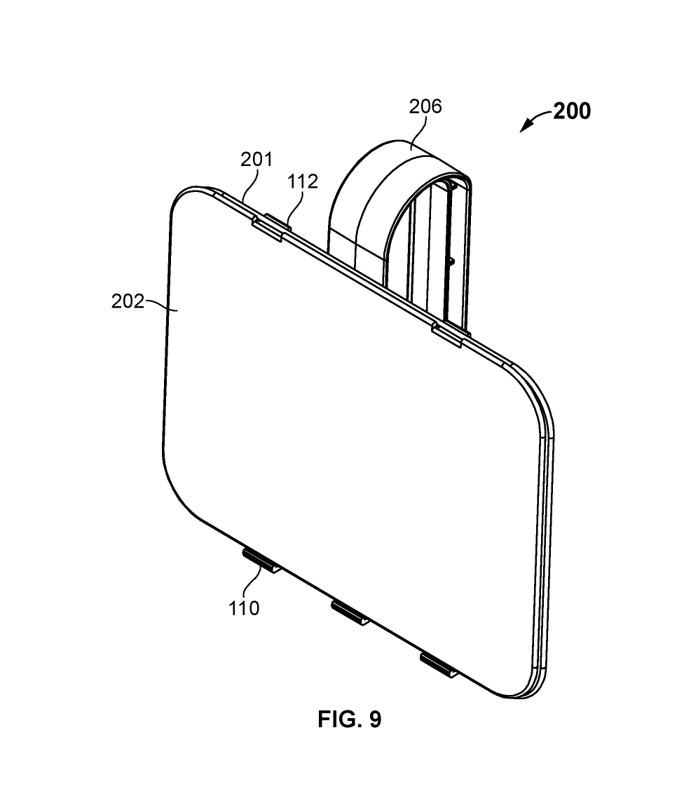

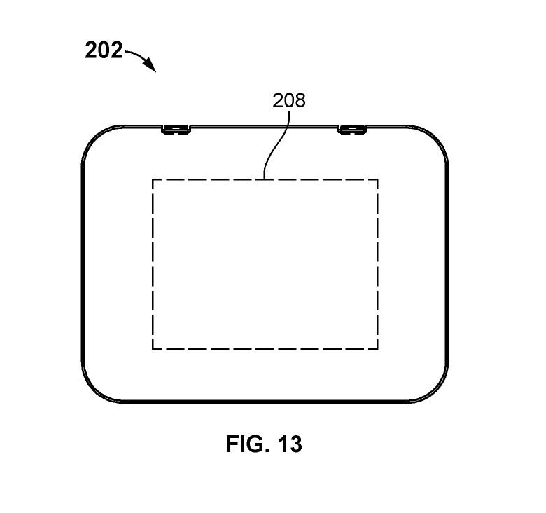

FIG. 9 exemplarily illustrates a perspective view of the apparatus 200 in an embodiment of the present invention. Referring to FIGS. 9-13, in one embodiment, the apparatus 200 comprises a frame 201, a frame cover 202, a visor clip mount 204 and a visor clip 206. In one embodiment, the frame 201 and the frame cover 202 comprise a predefined dimension. The frame 201 comprises one or more flanges 110 extends from a peripheral edge of the frame 201, to fasten with the frame cover 202. In one embodiment, the frame cover 202 comprises a recess 208, shown in FIG. 13, of predefined dimensions for receiving a picture or photograph. The flanges 110 are adapted to overhang the frame cover 202 to secure the frame cover 202, picture and frame 201 in assembled condition. The visor clip mount 204 is disposed at a rear side of the frame 201 configured to receive a visor clip 206.

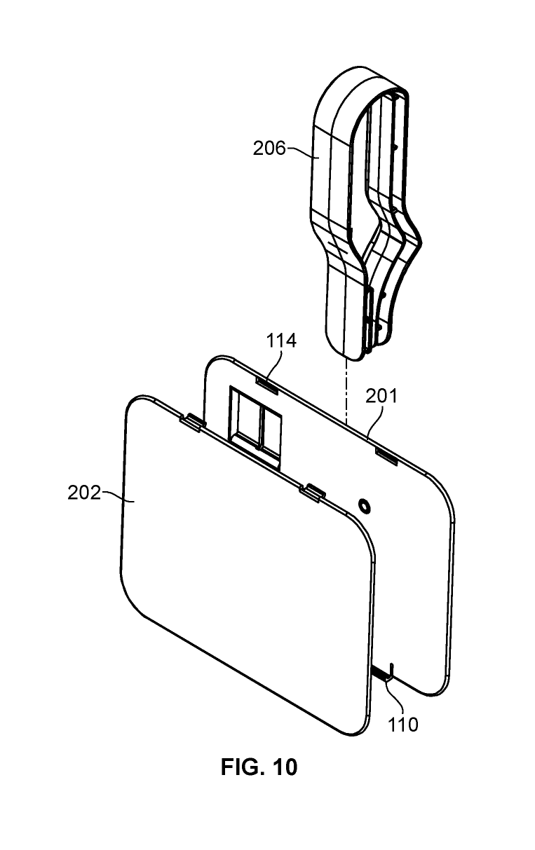

FIG. 10 exemplarily illustrates an exploded view of the apparatus 100 comprising the frame 201, frame cover 202 and the visor clip 206 in an embodiment of the present invention. The visor clip 206 is fastened to the visor clip mount 204 via a snap fit configuration.

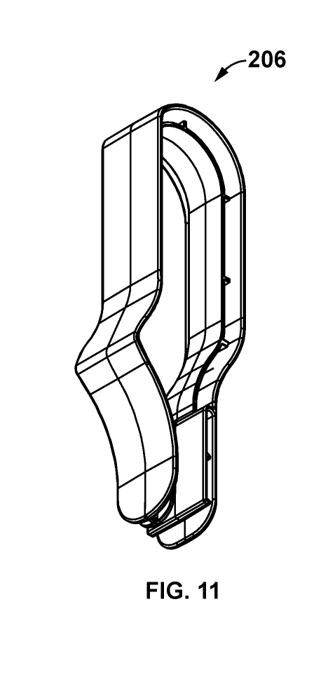

FIG. 11 exemplarily illustrates a perspective view of a visor clip 206 in an embodiment of the present invention. In one embodiment, the visor clip 206 comprises a U-shaped configuration. The U-shape configuration comprises at least two legs including a first leg and a second leg, wherein a lateral end of the first leg angled inwards and a lateral end of a second leg is angled outwards to form a ridge.

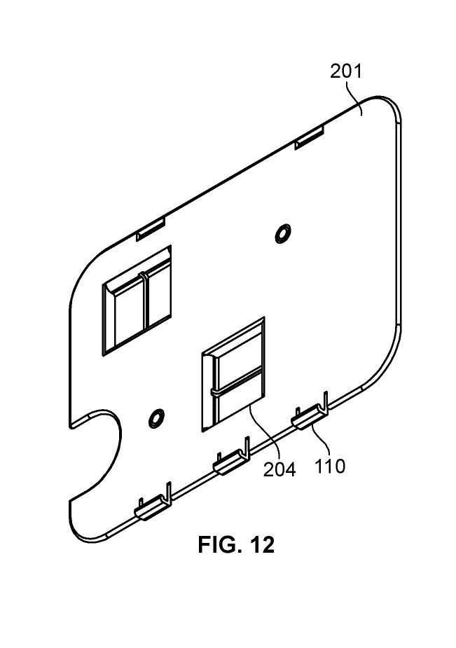

FIG. 12 exemplarily illustrates a front perspective of the frame 201 in an embodiment of the present invention. Referring to FIG. 10 and FIG. 12, in one embodiment, the frame cover 202 further comprises hinges 112, that insert into hinge openings 114 in the frame 201 and allow the cover 202 to rotate forward as well as be removed. FIG. 13 exemplarily illustrates a top view of a frame cover 202 comprising recess 208 in an embodiment of the present invention.

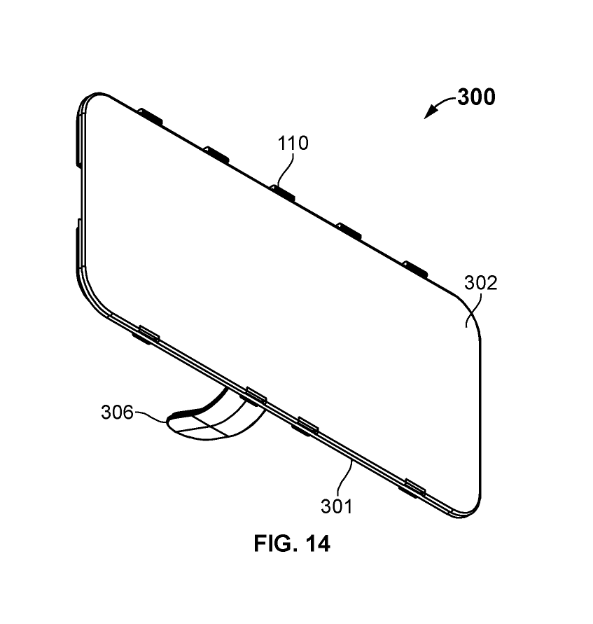

FIG. 14 exemplarily illustrates a perspective view of the apparatus 300 in another embodiment of the present invention. Referring to FIG. 14-18, in one embodiment, the apparatus 300 comprises a frame 301, a frame cover 302, a visor clip mount 304 and a visor clip 306. In one embodiment, the frame 301 and the frame cover 302 comprise a predefined dimension. The frame 301 comprises one or more flanges 110 extends from a peripheral edge of the frame 301, to fasten with the frame cover 302. In one embodiment, the frame cover 302 comprises at least two recess 116 of predefined dimensions for receiving a picture or photograph. The flanges 110 are adapted to overhang the front cover to secure the frame cover 302, picture and frame 301 in assembled condition. The visor clip mount is disposed at a rear side of the frame 301 configured to receive a visor clip 306.

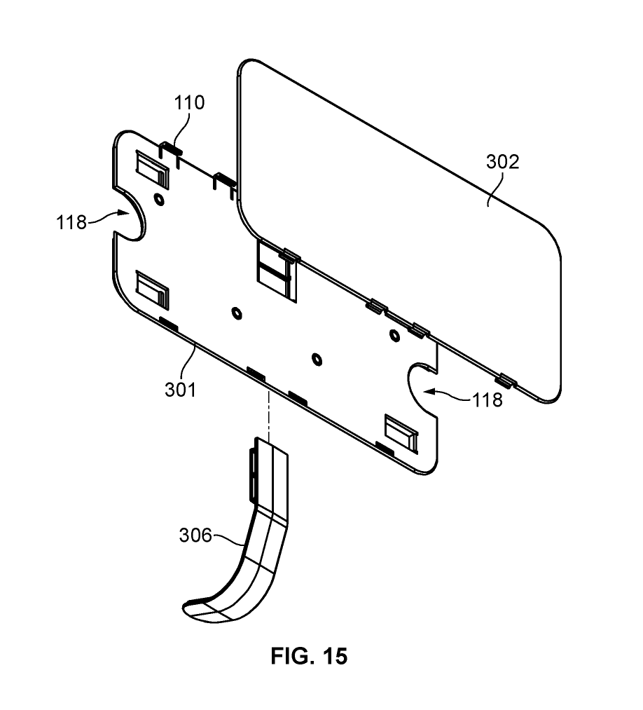

FIG. 15 exemplarily illustrates an exploded view of the apparatus 300 comprising the frame 301, frame cover 302 and the visor clip 306 in another embodiment of the present invention. The visor clip 306 is fastened to the visor clip mount 304 via a snap fit configuration.

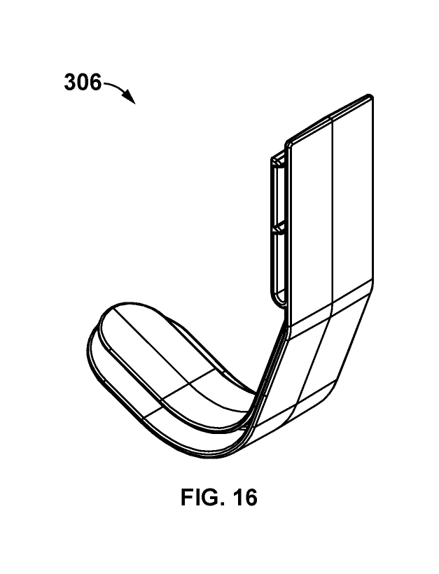

FIG. 16 exemplarily illustrates a perspective view of a visor clip 306 in another embodiment of the present invention. In one embodiment, the visor clip 306 comprises a L-shaped configuration.

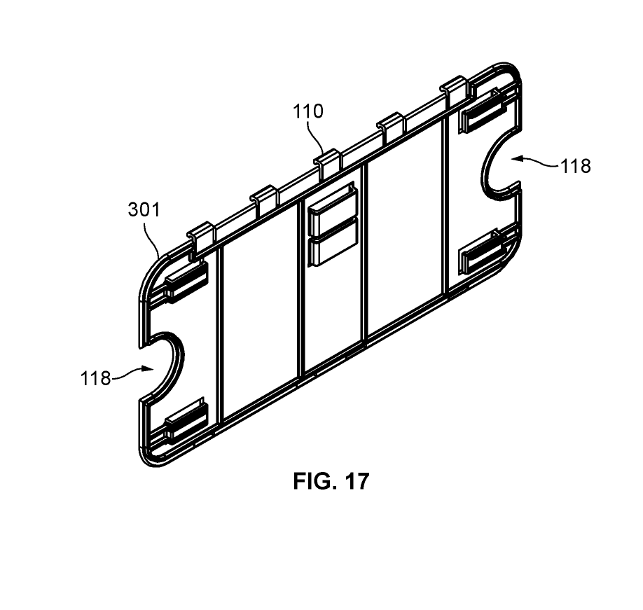

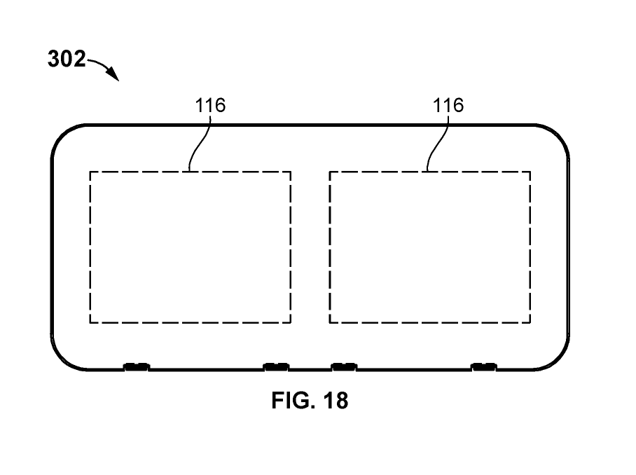

FIG. 17 exemplarily illustrates a front perspective of the frame 301 in an embodiment of the present invention. FIG. 18 exemplarily illustrates a top view of a frame cover 300 in another embodiment of the present invention. The frame cover 302 comprises at least two recess 116 of predefined dimensions formed thereon for receiving a picture or photograph. Advantageously, the present invention could be used on any surface such as a flat surface and surface like automobile visor.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

1. An apparatus for an auto visor and desk photo frame, the apparatus comprising:
a frame;
a frame cover;
at least two visor clips;
a visor clip retainer;
a visor clip lock
a visor clip mount;
a stand;
a stand retainer;
a stand lock; and,
a stand mount.

2. A frame apparatus, comprising:
a frame comprising one or more flanges extends from a peripheral edge of the frame;
a frame cover comprising at least two recess of predefined dimensions formed thereon
for receiving a picture or photograph, wherein the frame is fastened to the frame cover, wherein the flanges are adapted to overhang the frame cover to secure the frame, picture and transparent frame cover in assembled condition, and
a visor clip mount disposed at a rear side of the frame configured to receive a visor clip.

3. The apparatus of claim 2, wherein the visor clip mount comprises an upper mount and a lower mount on a same plane and a clip retainer adjacent to the upper mount, wherein the clip comprises a U-shaped configuration having a pair of legs, wherein the pair of legs comprises a first leg and a second leg having a circular hook-type end, and wherein the first leg is inserted into the upper mount and snapped into the lower mount, and a second leg is hooked to the clip retainer via the circular hook-type end.

4. The apparatus of claim 2, wherein the visor clip is characterized by a geometrical shape adapted to fasten to the visor clip mount via a snap fit configuration.

5. The apparatus of claim 2, wherein the visor clip is a L-shaped structure.

6. The apparatus of claim 2, wherein the visor clip is a U-shaped structure.

7. The apparatus of claim 2, wherein each recess is rectangular in shape.

8. A frame apparatus adapted to use on any surface structure, comprising:
a frame comprising one or more flanges extends from a peripheral edge of the frame;
a frame cover comprising at least two recess of predefined dimensions formed thereon
for receiving a picture or photograph, wherein the frame is fastened to the frame cover, wherein the flanges are adapted to overhang the frame cover to secure the frame, picture and transparent frame cover in assembled condition;
a stand mount comprising a pair of slots is disposed integrally at a rear side of the frame, wherein the stand mount is configured to hingedly fasten a stand, and a visor clip mount disposed at a rear side of the frame configured to receive a visor clip,
wherein the visor clip mount comprises an upper mount, a visor clip lock and a lower mount on a same plane and a clip retainer adjacent to the upper mount,
wherein the clip comprises a U-shaped configuration having a pair of legs,
wherein the pair of legs comprises a first leg and a second leg having a circular hook-type end, and
wherein the first leg is inserted into the upper mount and snapped into the lower mount, and a second leg is hooked to the clip retainer via the circular hook-type end.

9. The apparatus of claim 8, further comprises an inwardly formed groove at a rear side of a lower peripheral edge of the frame.

10. The apparatus of claim 8, wherein the stand is configured to retract inwardly to snugly fit in the groove of the lower peripheral edge of the frame.

11. The apparatus of claim 8, wherein the stand is configured to extend outwardly beyond the peripheral edge of the frame.

12. The apparatus of claim 8, further comprises one or more aperture disposed at the rear side of the frame to enable to adjust the position of the photograph.

13. The apparatus of claim 8, wherein the transparent frame cover further comprises one or more hinges at a lower peripheral edge.

14. The apparatus of claim 13, wherein the frame cover comprises hinge opening to receive each hinge therein on fastening the transparent frame cover to the frame.

15. The apparatus of claim 8, wherein the visor clip lock is disposed between the upper mount and the lower mount.

16. The apparatus of claim 8, wherein the visor clip lock comprises a dent configured to lock the visor clip in 90°.

17. A frame apparatus, comprising:
a frame comprising one or more flanges extends from a peripheral edge of the frame;
a frame cover comprising at least two recess of predefined dimensions formed thereon
for receiving a picture or photograph, wherein the frame is fastened to the frame cover, wherein the flanges are adapted to overhang the frame cover to secure the frame, picture and transparent frame cover in assembled condition, and
a visor clip mount disposed adjacent at a rear side of the frame cover configured to receive a visor clip.
wherein the visor clip comprises a characteristic shape adapted to fasten to the visor clip mount via a snap fit configuration.

18. The apparatus of claim 17, wherein each recess is rectangular in shape.
